(19) United States
(12) Patent Application Publication
(10) Pub. No.: US 2026/0172474 A1
(43) Pub. Date: Jun. 18, 2026

(54) DATA TRANSMISSION METHOD AND SYSTEM

(71) Applicant: CLOUD INTELLIGENCE ASSETS HOLDING (SINGAPORE) PRIVATE LIMITED, Singapore (SG)

(72) Inventor: Linbo HE, Hangzhou (CN)

(21) Appl. No.: 18/853,384

(22) PCT Filed: Apr. 3, 2023
(86) PCT No.: PCT/CN2023/085828

§ 371 Date: Oct. 1, 2024

(30) Foreign Application Priority Data
Apr. 6, 2022 (CN) 202210356688.1

(51) Int. Cl. H04L 67/12

(52) U.S. Cl. CPC H04L 67/12

(57) ABSTRACT

Embodiments of the present specification provide a data transmission method and system. The method is applied to the data transmission system, where the data transmission system includes a master node, at least two worker nodes, and a data acquiring worker node and a coordination worker node determined from the at least two worker nodes, and the method includes: in response to a first data acquiring instruction sent by the data acquiring worker node, sending, by the master node, target data to the data acquiring worker node; receiving, by the data acquiring worker node, the target data sent by the master node, and storing the target data to the coordination worker node; in response to a second data acquiring instruction sent by a further worker node, sending, by the coordination worker node, the target data to the further worker node.

### CROSS-REFERENCE TO RELATED APPLICATIONS

The present application is a national stage of International Application No. PCT/CN2023/085828, filed on Apr. 3, 2023, which claims priority to Chinese Patent Application No. 202210356688.1, entitled “Data Transmission Method and System” and filed with the China National Intellectual Property Administration on Apr. 6, 2022. Both of the aforementioned applications are hereby incorporated by reference in their entireties.

### TECHNICAL FIELD

The present application relates to the field of data processing technologies and, in particular, to a data transmission method.

### BACKGROUND

A kubernetes system is becoming more and more popular in an edge computing scenario. In a cloud-managing-edge architecture, a kubernetes master is deployed in a cloud, a kubernetes worker and project pods are deployed in an edge environment (closer to a user site), and a worker and a master of K8s are connected through a public network. And since edge nodes are generally not configured with a public network address, the K8s master cannot directly access the worker. When a Kubernetes cluster in the cloud-managing-edge architecture exceeds a certain scale (for example: nodes>10 k, pod>200 k, service>10 k), and when an edge project Pod is deleted and rebuilt, requests for endpoints/endpointslices resources from all edge nodes will be triggered, thus leading to a significant increasing in cloud-edge communication traffic. At the same time, requests for Node resources from all edge nodes will be triggered by an online and offline of the edge nodes, which will also lead to a significant increasing in cloud-edge traffic. The instantaneous and significant increase in cloud-edge traffic may even reach a traffic limitation of a cloud traffic outlet (for example, Server Load Balancer (SLB)), resulting in edge request overflow and errors. Therefore, how to reduce public network communication traffic at the cloud-edge has become an urgent problem to be solved.

### SUMMARY

In view of this, embodiments of the present specification provide a data transmission method. One or more embodiments of the present specification also relate to a method for communication between a cloud master node and an edge node, a data transmission apparatus, a computing device, a computer readable storage medium and a computer program to solve technical deficiencies existing in the prior art.

According to a first aspect of embodiments of the present specification, a data transmission method is provided, which is applied to a data transmission system, where the data transmission system includes a master node, at least two worker nodes, and a data acquiring worker node and a coordination worker node determined from the at least two worker nodes, the method includes:
in response to a first data acquiring instruction sent by the data acquiring worker node, sending, by the master node, target data to the data acquiring worker node;
receiving, by the data acquiring worker node, the target data sent by the master node, and storing the target data to the coordination worker node;
in response to a second data acquiring instruction sent by a further worker node, sending, by the coordination worker node, the target data to the further worker node, where the further worker node is a worker node other than the coordination worker node among the at least two worker nodes.

According to a second aspect of the embodiments of the present specification, a method for communication between a cloud master node and an edge node is provided, which is applied to a data transmission system, where the data transmission system includes the cloud master node, at least two edge nodes, and a data acquiring edge node and a coordination edge node determined from the at least two edge nodes, the method includes:
in response to a first data acquiring instruction sent by the data acquiring edge node, sending, by the cloud master node, target data to the data acquiring edge node;
receiving, by the data acquiring edge node, the target data sent by the cloud master node, and storing the target data to the coordination edge node;
in response to a second data acquiring instruction sent by a further edge node, sending, by the coordination edge node, the target data to the further edge node, where the further edge node is an edge node other than the coordination edge node among the at least two edge nodes.

According to a third aspect of the embodiments of the present specification, a data transmission system is provided, including a master node, at least two worker nodes, and a data acquiring worker node and a coordination worker node determined from the at least two worker nodes, where,
the master node is configured to in response to a first data acquiring instruction sent by the data acquiring worker node, send target data to the data acquiring worker node;
the data acquiring worker node is configured to receive the target data sent by the master node and store the target data to the coordination worker node;
the coordination worker node is configured to in response to a second data acquiring instruction sent by a further worker node, send the target data to the further worker node, where the further worker node is a worker node other than the coordination worker node among the at least two worker nodes.

According to a fourth aspect of the embodiments of the present specification, a data transmission apparatus is provided, which is applied to a data transmission system, where the data transmission system includes a main module, at least two sub-modules, and a data acquiring sub-module and a coordination sub-module determined from the at least two sub-modules, and the apparatus includes:
the main module, configured to in response to a first data acquiring instruction sent by the data acquiring worker node, send target data to the data acquiring worker node;
the data acquiring sub-module, configured to receive the target data sent by the master node and store the target data to the coordination worker node;
the coordination sub-module, configured to in response to a second data acquiring instruction sent by a further sub-module, send the target data to the further sub-module, where the further sub-module is a sub-module other than the coordination sub-module among the at least two sub-modules.

According to a fifth aspect of the embodiments of the present specification, a computing device is provided, including:
a memory and a processor;
the memory is used to store computer executable instructions, the processor is used to execute the computer executable instructions, when the computer executable instructions are executed by the processor, steps of the above data transmission method are implemented.

According to a sixth aspect of the embodiments of the present specification, a computer readable storage medium is provided, which stores computer executable instructions, when the instructions are executed by a processor, steps of the above data transmission method are implemented.

According to a seventh aspect of the embodiments of the present specification, a computer program is provided, where when the computer program is executed in a computer, the computer is caused to execute the steps of the above data transmission method.

Embodiments of the present specification provide a data transmission method and system, the method is applied to the data transmission system, where the data transmission system includes a master node, at least two worker nodes, and a data acquiring worker node and a coordination worker node determined from the at least two worker nodes, and the method includes: in response to a first data acquiring instruction sent by the data acquiring worker node, sending, by the master node, target data to the data acquiring worker node; receiving, by the data acquiring worker node, the target data sent by the master node, and storing the target data to the coordination worker node; in response to a second data acquiring instruction sent by a further worker node, sending, by the coordination worker node, the target data to the further worker node, where the further worker node is a worker node other than the coordination worker node among the at least two worker nodes. By determining a data acquiring worker node among the worker nodes and the data acquiring worker node acquiring the target data from the master node and storing it to the coordination worker node, when acquiring data, not every worker node needs to acquire the data from the master node, so as to reduce communication traffic between the master node and the worker nodes.

### BRIEF DESCRIPTION OF DRAWINGS

FIG. 1 is a flowchart of a data transmission method provided by an embodiment of the present specification.

FIG. 2 is a flowchart of a method for communication between a cloud master node and an edge node provided by an embodiment of the present specification.

FIG. 3 is a schematic diagram of a method for communication between a cloud master node and an edge node provided by an embodiment of the present specification.

FIG. 4 is a schematic structural diagram of a data transmission apparatus provided by an embodiment of the present specification.

FIG. 5 is a structural block diagram of a computing device provided by an embodiment of the present specification.

### DESCRIPTION OF EMBODIMENTS

In the following description, many specific details are illustrated to facilitate a full understanding of the present specification. However, the present specification can be implemented in many other ways different from those described herein. Those skilled in the art may make similar extensions without violating the connotation of the present specification. Therefore, the present specification is not limited by the specific embodiments disclosed below.

The terminology used in one or more embodiments of the present specification is for the purpose of describing particular embodiments only, and is not intended to limit the one or more embodiments of the present specification. As used in one or more embodiments of the present specification and the appended claims, singular forms “a,” “the said” and “the” are also intended to include plural forms, unless otherwise specified by the context. It should also be understood that the term “and/or” as used in one or more embodiments of the present specification refers to and includes any and all possible combinations of one or more of the associated listed items.

It should be understood that although the terms first, second, etc. may be used to describe various information in one or more embodiments of the present specification, the information should not be limited to these terms. These terms are only used to distinguish information of the same type from each other. For example, without departing from the scope of one or more embodiments of the present specification, the first may also be called the second, and similarly, the second may also be called the first. Depending on the context, the word “if” used herein may be interpreted as “at the time of”, “when”, “in response to determining”.

First, terminology involved in one or more embodiments of the present specification will be explained.
Kubernetes: an open source system for automating deployment, scaling and managing containerized applications.
list/watch: a data access mechanism in Kubernetes.
Kubelet: a main service on a worker node, regularly receives new or modified Pod specifications from a kube-apiserver component and ensures that the Pod and its containers run under expected specifications.
Kube-proxy: maintains a network rule on a node and realizes a part of a Kubernetes Service concept. Its function is to balance traffic (via ClusterIP and port) load sent to Service to a correct backend Pod.
YurtHub: a reverse proxy for client Request.
Transmission control protocol (TCP, Transmission Control Protocol): a transport layer communication protocol which is connection oriented, reliable, based on byte stream.
Lease: a heartbeat sent by Kubernetes nodes to determine an availability of each node, is a lightweight resource.
Pod: Pod is a smallest deployable computing unit which may be created and managed in Kubernetes, containing one or more application containers.
Node pool (NodePool): multiple nodes with a same attribute and characteristic (such as being deployed in a same physical area and accessible to each other) in Kubernetes cluster and its extended cluster.
Pool Scope Data: data acquired by each node in NodePool from the cloud is the same, such as the data returned by “list” requests for Node, Endpointslices, Endpoints, Services and other resources.
Node Scope Data: data acquired by each node in NodePool from the cloud is unique to this node, such as the data returned by “get” requests for Pods, Secrets, Configmaps and other resources.
Edge node: refers to a project platform built at a network edge side close to a user, provides storage, computing, network and other resources, and sinks some key project applications to an access network edge to reduce a width and a delay loss brought by a network transmission and multi-level forwarding. The edge node is located between the user and a cloud center.
Election: is a decision process.

In order to prevent a significant increase in cloud-edge traffic due to possible triggering of an edge list/watch request by recovering a cloud-edge (cloud and edge) network which is disconnected for a long time, in some cloud-managing-edge architectures, in order to reduce the cloud-edge traffic, a native list/watch request in Kubernetes is abandoned, and instead the cloud actively pushes data to the edge. The specific scheme is described below.

First, when the edge node is connected to the cloud cluster, a tcp long connection is built between the edge node and the cloud cluster. At the same time, a controller (controller) is increased in the cloud cluster to monitor (list/watch) a data change of the cloud cluster in real time. When the controller detects the data change, changed data is pushed to each edge node through the tcp long connection of the cloud-edge cluster. Through an active push of data from the cloud, an active list operation at the edge is reduced, and cloud-edge communication data is reduced.

Although this scheme can reduce the traffic of list requests in some scenarios (recovering the cloud-edge network which is disconnected for a long time), it has shortcomings. For example, the list/watch mechanism is an underlying mechanism for a communication between components in the Kubernetes system, and the list/watch mechanism is abandoned, which means that a destructive and intrusive modification is performed on the Kubernetes system, resulting in applications of cloud native ecology using the list/watch mechanism on edge nodes are unable to run. And in most scenarios, when cloud resources (such as endpoints) change, the cloud still needs to push data to each edge node. Therefore, cloud-edge traffic will not be reduced in most scenarios, and the traffic may be reduced only in some scenarios, and a reduction effect of cloud edge communication data is not good. And because the cloud actively pushes data to the edge nodes, which means that the cloud does not know what type of data the edge nodes need, the cloud needs to push all types of data to the edge nodes. Therefore, a lot of invalid data push will occur, resulting in a waste of the cloud-edge traffic.

Based on this, in the present specification, a data transmission method is provided. The present specification also relates to a method for communication between a cloud master node and an edge node, a data transmission apparatus, a computing device, and a computer readable storage medium, which will be described in detail one by one in the following embodiments.

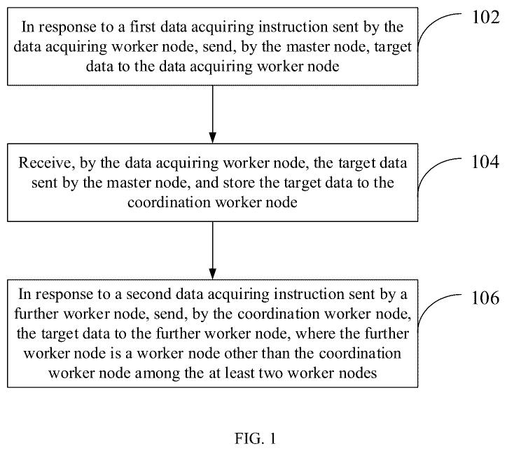

Referring to FIG. 1, FIG. 1 shows a flowchart of a data transmission method provided by an embodiment of the present specification, which is applied to a data transmission system, where the data transmission system includes a master node, at least two worker nodes, and a data acquiring worker node and a coordination worker node determined from the at least two worker nodes. The master node in the embodiment may be understood as the aforementioned cloud, the worker node in the embodiment may be understood as the aforementioned edge node, and the coordination worker node is configured in advance, and the data transmission method specifically includes the following steps.

Step 102, in response to a first data acquiring instruction sent by the data acquiring worker node, send, by the master node, target data to the data acquiring worker node.

The data acquiring worker node may be any worker node, and there is a communication connection between this node and the master node; the first data acquiring instruction may be a list/watch request in Kubernetes; the target data may be Node Scope Data in the terminology explanation, such as data returned by “get” requests for Pods, Secrets, Configmaps and other resources

In an actual application, all worker nodes belong to a same node pool (NodePool), and nodes in the node pool may transmit data to each other. The data acquiring worker node in the node pool sends the first data acquiring instruction to the master node, and in a case that the master node receives the first data acquiring instruction, the master node sends corresponding data to the data acquiring worker node.

For example, the worker nodes include a worker node A and a worker node B. The worker node B is the data acquiring worker node. Then the worker node B sends the first data acquiring instruction to the master node, in a case that the master node receives the first data acquiring instruction, the master node sends the target data to the worker node B.

In the embodiment of the present specification, the target data is acquired through one node, so that the target data may be stored later, and other nodes acquire the target data from the node pool, thereby other nodes do not request the target data from the master node, and communication traffic is reduced.

Step 104, receive, by the data acquiring worker node, the target data sent by the master node, and store the target data to the coordination worker node.

In an actual application, after receiving the target data, the data acquiring worker node stores the target data in a pre-configured coordination worker node, so that other worker nodes acquire data from the coordination worker node.

For example, the worker nodes include the worker node A, the worker node B and a worker node C. The worker node B is the data acquiring worker node, and the worker node C is the coordination worker node. Then the worker node B sends the first data acquiring instruction to the master node, and in a case that the master node receives the first data acquiring instruction, the master node sends the target data to the worker node B, and the worker node B stores the target data to the worker node C.

In a feasible manner, the data acquiring worker node may be obtained through an election manner, and the specific implementation is as follows:
sending, by the at least two worker nodes, lock instructions to the coordination worker node;
receiving, by the coordination worker node, the lock instructions sent by the at least two worker nodes, and in a case that a lock instruction is received, determining the data acquiring worker node according to the lock instructions.

The lock instructions may be understood as instructions to modify the data which is thus locked. For example, in a case that an initial value of data X is 0, a value of data X is modified to 1, which means that the value of data X has been locked and cannot be changed. Conventional technical means in the art may be used for such locking mechanism, which is not limited in the embodiments of the present specification.

For example, the worker nodes include the worker node A, the worker node B and the worker node C. The worker node C is the coordination worker node. Then the worker node A and the worker node B send the lock instructions to the worker node C. If a lock instruction of the worker node B arrives at the worker node C first, and a data value for the locking mechanism is modified from 0 to 1, and the worker node B sends a connection request to the master node, in a case that the lock instruction of the worker node A arrives at the worker node C, the data value for the lock mechanism has been found to be 1, and thus it can be known that an election has been successful made and the worker node B may be acquired as the data acquiring worker node.

It should be noted that in order to ensure that the worker node and a cloud network are connected, a necessary condition for the worker node to participate in the election is to be connected to the cloud network.

In the embodiment of the present specification, the data acquiring worker node is determined through the election manner. Therefore, the worker node with a smaller communication delay can be determined as the data acquiring worker node, and communication efficiency can be improved.

In a feasible manner, on the basis of a service module existing in each worker node, a proxy module is added into the worker node. The proxy module is used to intercept a data acquiring request made by the service module to realize that a data request from each worker node is forwarded to the coordination worker node, and the specific implementation is as follows.

Specifically, each of the at least two worker nodes includes the service module and the proxy module;
before the coordination worker node responds to the second data acquiring instruction sent by the further worker node, the method further includes:
sending, by the service module of the further worker node, the second data acquiring instruction to the master node;
intercepting, by the proxy module of the further worker node, the second data acquiring instruction, and sending the second data acquiring instruction to the coordination worker node.

The service module may be Kubelet, Kube-proxy, etc. ; the proxy module may be YurtHub, etc.

In an actual application, the service module should send the second data acquiring instruction to the master node and request the target data from the master node. Then the proxy module may be added into the each worker node, and the proxy module intercepts the second data acquiring instruction which should be sent to the master node by the service module in the worker node where the proxy module is located, and sends the second data acquiring instruction to the coordination worker node.

For example, the worker nodes include the worker node A, the worker node B, and the worker node C. Each of the worker node A, the worker node B, and the worker node C includes the service module and the proxy module. The worker node C is the coordination worker node, and the worker node B is the data acquiring worker node. In a case that the service module in the worker node A needs to request the data from the master node, the service module sends the second data acquiring instruction to the master node. The proxy module in the worker node A intercepts the second data acquiring instruction and redirects the second data acquiring instruction to the worker node C to acquire the target data. Correspondingly, in a case that the service module in worker node B needs to request the data from the master node, the service module sends the second data acquiring instruction to the master node. The proxy module in the worker node B intercepts the second data acquiring instruction and redirects the second data acquiring instruction to the worker node C. In a case that the service module in the worker node C needs to request the data from the master node, the service module sends the second data acquiring instruction to the master node. The proxy module in the worker node C intercepts the second data acquiring instruction and redirects the second data acquiring instruction to a local address.

In the embodiment of the present specification, in a native Kubernetes architecture, a proxy module is added into the edge node to take over the communication traffic between the worker node and the master node. No modifications are made to the Kubernetes architecture, and the applications of cloud native ecology may run on edge node very well. And all requests are initiated by a data demander (edge node), invalid traffic will not be generated by the cloud-edge communication.

Correspondingly, the data acquiring worker node in the above embodiment may be obtained through the election manner, and the first data acquiring instruction being sent to the master node may be performed by the proxy module. For example, the worker nodes include the worker node A, the worker node B and the worker node C. The worker node C is the coordination worker node. Then the proxy module of the worker node A and the proxy module of the worker node B send the lock instructions to the worker node C. If a lock instruction from the proxy module of the worker node B arrives at the worker node C first, and a data value for the locking mechanism is modified by from 0 to 1, and the proxy module of the worker node B sends a connection request to the master node, and in a case that the lock instruction from the proxy module of the worker node A arrives to the worker node C, the data value for the lock mechanism has been found to be 1, and thus it can be known that the election has been successful made and the worker node B may be acquired as the data acquiring worker node.

In a feasible manner, in addition to the target data, the worker node will acquire data according to demands of its own internal service module, so the data needs to be acquired directly from the master node. The specific implementation is as follows:
acquiring, by a target worker node among the at least two worker nodes, demand data from the coordination worker node, and in a case that the demand data does not exist in the coordination worker node, sending a third data acquiring instruction to the master node;
in response to the third data acquiring instruction, sending, by the master node, the demand data to the target worker node;
receiving, by the target worker node, the demand data, where the demand data is other data in the master node except the target data.

The demand data may be Node Scope Data, such as data returned by “get” requests for Pods, Secrets, Configmaps and other resources; the third data acquiring instruction may be the list/watch request in Kubernetes.

For example, the worker nodes include the worker node A, the worker node B, and the worker node C. Each of the worker node A, the worker node B, and the worker node C includes the service module and the proxy module. The worker node C is the coordination worker node, and the worker node B is the data acquiring worker node. In a case that the service module of the worker node A needs to request data from the master node, the service module of the worker node A sends the third data acquiring instruction to the master node. The proxy module of the worker node A intercepts the third data acquiring instruction and redirects the third data acquiring instruction to the worker node C to acquire the corresponding data. When the worker node C finds that the data corresponding to the third data acquiring instruction is not stored therein, the worker node C notifies the worker node A, the worker node A directly sends the third data acquiring instruction to the master node, and the master node returns the data corresponding to the third data acquiring instruction to the worker node A.

In the embodiment of the present specification, when a worker node has a separate demand, the worker node directly requests data from the master node, without occupying a storage space of a coordination worker node.

In a feasible manner, the target data may change, or the worker node needs to actively update the data, then a request for updating the target data is needed to be made to the master node. The specific implementation is as follows:
sending, by the data acquiring worker node, a data update instruction to the master node;
in response to the data update instruction, sending, by the master node, updated data to the data acquiring worker node;
acquiring, by the data acquiring worker node, the updated data from the master node, and storing the updated data to the coordination worker node, where the updated data is changed data in the target data.

For example, the worker node C is the coordination worker node, and the worker node B is the data acquiring worker node. The worker node B is set to send the data update instruction to the master node every 24 hours. In response to the data update instruction, the master node sends updated data of the target data to the worker node B. After receiving the updated data, the worker node B sends the updated data to the worker node C, and the worker node C modifies the target data according to the updated data.

In the embodiment of the present specification, the target data is modified according to the updated data instead of transmitting entire target data, thereby reducing communication traffic.

Step 106, in response to the second data acquiring instruction sent by a further worker node, send, by the coordination worker node, the target data to the further worker node, where the further worker node is a worker node other than the coordination worker node among the at least two worker nodes.

The second data acquiring instruction may be the list/watch request in Kubernetes.

In an actual application, when the data request for the target data of each worker node passes through each proxy module, the proxy module forwards the request to the coordination worker node, and acquires latest written target data from the coordination worker node, thereby increasing an effect of reusing cloud-edge traffic and reducing public network communication traffic.

In a feasible manner, on the basis of the existence of the service module and the proxy module in each worker node, a coordination module is added into a worker node to configure the worker node as the coordination worker node, and the coordination module is configured to manage the target data. The specific implementation is as follows:
the coordination worker node further includes the coordination module;
receiving, by the coordination module, the second data acquiring instruction sent by any one of proxy modules, and sending the target data to the proxy module;
in a case that the target data is received, sending, by the proxy module, the target data to a corresponding service module.

The coordination module may be understood as a module that manages the target data, for example, a node pool coordinator (pool-assistant). It should be noted that the node pool coordinator may be deployed on any worker node, which is not limited in the embodiments of the present specification.

For example, the worker nodes include the worker node A, the worker node B, and the worker node C. Each of the worker node A, the worker node B, and the worker node C includes the service module and the proxy module. The worker node C is the coordination worker node, and the worker node B is the data acquiring worker node. In a case that the service module of the worker node A needs to request the data from the master node, it sends the second data acquiring instruction to the master node. The proxy module of the worker node A intercepts the second data acquiring instruction and redirects the second data acquiring instruction to the worker node C. After receiving the second data acquiring instruction from the worker node A, the coordination module of the worker node C sends the target data to the worker node A. The target data passes through the proxy module of worker node A and is forwarded to a corresponding service module. Correspondingly, after receiving the second data acquiring instruction from the worker node B, the coordination module of the worker node C sends the target data to the worker node B. The target data passes through the proxy module of the worker node B and is forwarded to a corresponding service module. After receiving the second data acquiring instruction from the proxy module of the worker node C, the coordination module of the worker node C directly sends the target data to the proxy module of the worker node C. The target data passes through the proxy module of the worker node C and is forwarded to a corresponding service module.

In the embodiment of the specification, no modifications are made to Kubernetes. Applications of cloud native ecology can run well on the edge and share an ability of reusing traffic.

In a feasible manner, acquiring the target data from the master node, storing the target data, and providing the target data to the worker node in the node pool may all be implemented through the proxy module and the coordination module. The specific implementation is as follows:
sending, by the proxy module of the data acquiring worker node, the first data acquiring instruction to the master node;
in response to the first data acquiring instruction, sending, by the master node, the target data to the proxy module of the data acquiring worker node;
receiving, by the proxy module of the data acquiring worker node, the target data sent by the master node, and storing the target data to the coordination module of the coordination worker node.

For example, the worker nodes include the worker node A, the worker node B and the worker node C. The worker node B is the data acquiring worker node, and the worker node C is the coordination worker node. Each of the worker node A, the worker node B and the worker node C includes the service module and the proxy module, and the worker node C further includes the coordination module. The proxy module of the worker node B sends the first data acquiring instruction to the master node. In a case that the master node receives the first data acquiring instruction, the master node sends the target data to the worker node B. The proxy module of the worker node B sends the target data to the coordination module of the worker node C.

Further, the storing the target data to the coordination module of the coordination worker node includes:
sending, by the proxy module of the data acquiring worker node, the target data to the coordination module, so that the coordination module receives the target data and writes the target data into a storage.

The storage may be a hard disk, a memory and other storage media.

Following the above example, after the coordination module of the worker node C receives the target data, the coordination module writes the target data to the hard disk.

It should be noted that even in a case that the worker node is disconnected from the network, the worker nodes in all node pools can still acquire the target data from the coordination node.

Embodiments of the present specification provide a data transmission method, which is applied to a data transmission system, where the data transmission system includes a master node, at least two worker nodes, and a data acquiring worker node and a coordination worker node determined from the at least two worker nodes, and the method includes: in response to a first data acquiring instruction sent by the data acquiring worker node, sending, by the master node, target data to the data acquiring worker node; receiving, by the data acquiring worker node, the target data sent by the master node, and storing the target data to the coordination worker node; in response to a second data acquiring instruction sent by a further worker node, sending, by the coordination worker node, the target data to the further worker node, where the further worker node is a worker node other than the coordination worker node among the at least two worker nodes. By determining a data acquiring worker node among worker nodes and the data acquiring worker node acquiring the target data from the master node and storing it to the coordination worker node, when acquiring data, not every worker node needs to acquire the data from the master node, so as to reduce communication traffic between the master node and the worker node.

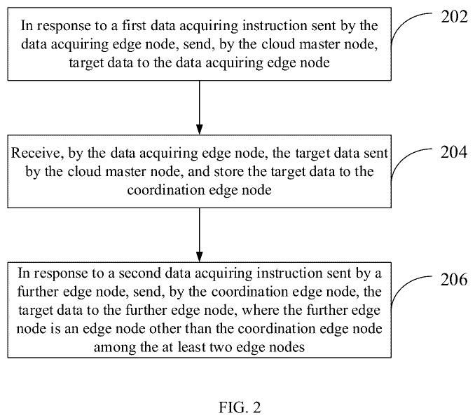

Referring to FIG. 2, FIG. 2 is a flowchart of a method for communication between a cloud master node and an edge node provided by an embodiment of the present specification. An embodiment of the present specification also provides a method for communication between a cloud master node and an edge node, which is applied to a data transmission system, where the data transmission system includes the cloud master node, at least two edge nodes, and a data acquiring edge node and a coordination edge node determined from the at least two edge nodes, and the method includes:
step 202, in response to a first data acquiring instruction sent by the data acquiring edge node, send, by the cloud master node, target data to the data acquiring edge node;
step 204, receive, by the data acquiring edge node, the target data sent by the cloud master node, and store the target data to the coordination edge node;
step 206, in response to a second data acquiring instruction sent by a further edge node, send, by the coordination edge node, the target data to the further edge node, where the further edge node is an edge node other than the coordination edge node among the at least two edge nodes.

In a feasible manner, the method further includes:
sending, by the at least two edge nodes, lock instructions to the coordination edge node;
receiving, by the coordination edge node, the lock instructions sent by the at least two edge nodes, and in a case that a lock instruction is received, determining the data acquiring edge node according to the lock instructions.

In a feasible manner, the method further includes:
acquiring, by a target edge node among the at least two edge nodes, demand data from the coordination edge node, and in a case that the demand data does not exist in the coordination edge node, sending a third data acquiring instruction to the cloud master node;
in response to the third data acquiring instruction, sending, by the cloud master node, the demand data to the target edge node;
receiving, by the target edge node, the demand data, where the demand data is other data in the cloud master node except the target data.

In a feasible manner, the method further includes:
sending, by the data acquiring edge node, a data update instruction to the cloud master node;
in response to the data update instruction, sending, by the cloud master node, updated data to the data acquiring edge node;
acquiring, by the data acquiring edge node, the updated data from the cloud master node, and storing the updated data to the coordination edge node, where the updated data is changed data in the target data.

In an feasible manner, each of the at least two edge nodes includes a service module and a proxy module;
before the coordination edge node responds to the second data acquiring instruction sent by the further edge node, the method further includes:
sending, by the service module of the further worker node, the second data acquiring instruction to the cloud master node;
intercepting, by the proxy module of the further worker node, the second data acquiring instruction, and sending the second data acquiring instruction to the coordination edge node.

In a feasible manner, the coordination edge node further includes a coordination module;
receiving, by the coordination module, the second data acquiring instruction sent by any one of proxy modules, and sending the target data to the proxy module;
in a case that the target data is received, sending, by the proxy module, the target data to a corresponding service module.

In a feasible manner, the method further includes:
sending, by the proxy module of the data acquiring edge node, the first data acquiring instruction to the cloud master node;
in response to the first data acquiring instruction, sending, by the cloud master node, the target data to the proxy module of the data acquiring edge node;
receiving, by the proxy module of the data acquiring edge node, the target data sent by the cloud master node, and storing the target data to the coordination module of the coordination edge node.

In a feasible manner, the storing the target data to the coordination module of the coordination edge node includes:
sending, by the proxy module of the data acquiring worker node, the target data to the coordination module, so that the coordination module receives the target data and writes the target data into a storage.

The cloud master node may be understood as a master (master node) of Kubernetes in the cloud.

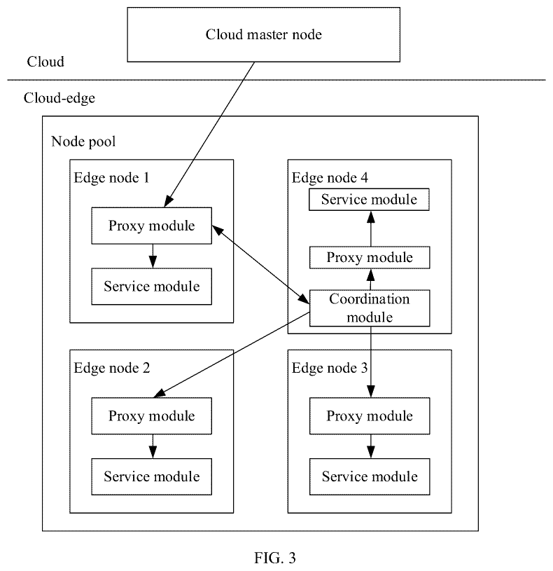

For example, refer to FIG. 3. FIG. 3 is a schematic diagram of a method for communication between a cloud master node and an edge node provided by an embodiment of the present specification. There is the cloud master node in a cloud, and a node pool in a cloud-edge. The node pool includes an edge node 1, an edge node 2, an edge node 3, and an edge node 4. The edge node 1 is a data acquiring edge node, the edge node 4 is a coordination edge node, each of the edge node 2, the edge node 1 and the edge node 4 includes a service module and a proxy module, and the edge node 4 further includes a coordination module. The proxy module of the edge node 1 sends a first data acquiring instruction to the cloud master node. In a case that the cloud master node receives the first data acquiring instruction, the cloud master node sends target data to the edge node 1, and the proxy module of the edge node 1 sends the target data to the coordination module of the edge node 4. The coordination module receives the target data sent by the proxy module of the data acquiring edge node, and writes the target data into a storage.

In a case that the service module of the edge node 2 needs to request data from the master node, it sends a second data acquiring instruction to the master node. The proxy module of the edge node 2 intercepts the second data acquiring instruction and redirects the second data acquiring instruction to the edge node 4. The coordination module of the edge node 4 receives the second data acquiring instruction from the edge node 2 and sends the target data to the edge node 2. The target data passes through the proxy module of the edge node 2 and is forwarded to the service module of the edge node 2.

Embodiments of the present specification provide a method for communication between a cloud master node and an edge node, which is applied to a data transmission system, where the data transmission system includes the cloud master node, at least two edge nodes, and a data acquiring edge node and a coordination edge node determined from the at least two edge nodes, and the method includes: in response to a first data acquiring instruction sent by the data acquiring edge node, sending, by the cloud master node, target data to the data acquiring edge node; receiving, by the data acquiring edge node, the target data sent by the cloud master node, and storing the target data to the coordination edge node; in response to a second data acquiring instruction sent by a further edge node, sending, by the coordination edge node, the target data to the further worker node, where the further edge node is an edge node other than the coordination edge node among the at least two edge nodes. By determining a data acquiring edge node among edge nodes and the data acquiring edge node acquiring the target data from the cloud master node and storing it to the coordination edge node, when acquiring data, not every edge node needs to acquire the data from the cloud master node, so as to reduce communication traffic between the cloud master node and the edge node.

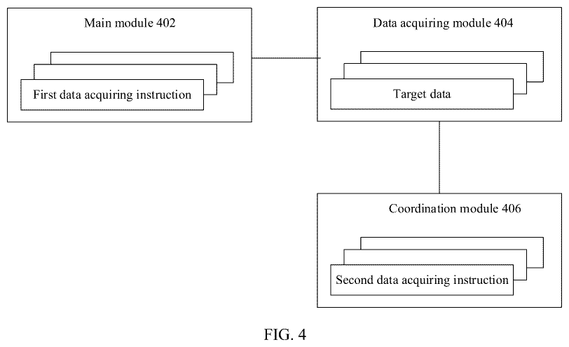

Corresponding to the above method embodiments, the present specification further provides an embodiment of a data transmission apparatus. FIG. 4 shows a schematic structural diagram of a data transmission apparatus provided by an embodiment of the present specification. As shown in FIG. 4, the apparatus is applied to a data transmission system, where the data transmission system includes a main module, at least two sub-modules, and a data acquiring sub-module and a coordination sub-module determined from the at least two sub-modules, and the apparatus includes:
the main module 402, configured to in response to a first data acquiring instruction sent by the data acquiring sub-module, send target data to the data acquiring sub-module;
the data acquiring sub-module 404, configured to receive the target data sent by the main module, and store the target data to the coordination sub-module;
the coordination sub-module 406, configured to in response to a second data acquiring instruction sent by a further sub-module, send the target data to the further sub-module, where the further sub-module is a sub-module other than the coordination sub-module among the at least two sub-modules.

In a feasible manner, the at least two sub-modules are configured to send lock instructions to the coordination sub-module;
the coordination sub-module is configured to receive the lock instructions sent by the at least two sub-modules, and in a case that a lock instruction is received, determine the data acquiring sub-module according to the lock instructions.

In a feasible manner, a target sub-module in the at least two sub-modules is configured to acquire demand data from the coordination sub-module, in a case that the demand data does not exist in the coordination sub-module, sending a third data acquiring instruction to the main module;
the main module is configured to in response to the third data acquiring instruction, send the demand data to the target sub-module;
the target sub-module is configured to receive the demand data, where the demand data is other data in the main module except the target data.

In a feasible manner, the data acquiring sub-module is configured to send a data update instruction to the main module;
the main module is configured to in response to the data update instruction, send updated data to the data acquiring sub-module;
the data acquiring sub-module is configured to acquire the updated data from the main module, and store the updated data to the coordination sub-module, where the updated data is changed data in the target data.

In a feasible manner, a proxy module of the data acquiring sub-module sends the first data acquiring instruction to the main module;
the main module is configured to in response to the first data acquiring instruction, send the target data to the proxy module of the data acquiring sub-module;
the proxy module of the data acquiring sub-module is configured to receive the target data sent by the main module, and store the target data to the coordination module of the coordination sub-module.

In a feasible manner, the proxy module of the data acquiring sub-module is configured to:
send the target data to the coordination module, so that the coordination module receives the target data and writes the target data into a storage.

In a feasible manner, each of the at least two sub-modules includes a service module and the proxy module;
before the coordination sub-module responding to the second data acquiring instruction sent by the further sub-module:
the service module of the further sub-module is configured to send the second data acquiring instruction;
the proxy module of the further sub-module is configured to intercept the second data acquiring instruction, and send the second data acquiring instruction to the coordination sub-module.

In a feasible manner, the coordination sub-module further includes the coordination module;
the coordination module is configured to receive the second data acquiring instruction sent by the proxy module, and send the target data to the proxy module;
the proxy module is configured to, in a case that the target data is received, send the target data to a corresponding service module.

An embodiment of the present specification provides a data transmission apparatus, which is applied to a data transmission system, where the data transmission system includes a master module, at least two sub-modules, and a data acquiring sub-module and a coordination sub-module determined from the at least two sub-modules, and the method steps executed by the apparatus include: in response to a first data acquiring instruction sent by the data acquiring sub-module, sending, by the main module, target data to the data acquiring sub-module; receiving, by the data acquiring sub-module, the target data sent by the main module, and storing the target data to the coordination sub-module; in response to a second data acquiring instruction sent by a further sub-module, sending, by the coordination sub-module, the target data to the further sub-module, where the further sub-module is a sub-module other than the coordination sub-module among the at least two sub-modules. By determining a data acquiring sub-module among sub-modules and the data acquiring sub-module acquiring the target data from the main module and storing it to the coordination sub-module, when acquiring data, not every sub-module needs to acquire the data from the main module, so as to reduce communication traffic between the main module and the sub-module.

An embodiment of the present specification further provides a data transmission system, including a master node, at least two worker nodes, and a data acquiring worker node and a coordination worker node determined from the at least two worker nodes, where,
the master node is configured to in response to a first data acquiring instruction sent by the data acquiring worker node, send target data to the data acquiring worker node;
the data acquiring worker node is configured to receive the target data sent by the master node, and store the target data to the coordination worker node;
the coordination worker node is configured to in response to a second data acquiring instruction sent by a further worker node, send the target data to the further worker node, where the further worker node is a worker node other than the coordination worker node among the at least two worker nodes.

In a feasible manner, the at least two worker nodes are configured to send lock instructions to the coordination worker node;
the coordination worker node is configured to receive the lock instructions sent by the at least two worker nodes, and in a case that a lock instruction is received, determining the data acquiring worker node according to the lock instructions.

In a feasible manner, a target worker node among the at least two worker nodes is configured to acquire demand data from the coordination worker node, and in a case that the demand data does not exist in the coordination worker node, send a third data acquiring instruction to the master node;
the master node is configured to in response to the third data acquiring instruction, send the demand data to the target worker node;
the target worker node is configured to receive the demand data, where the demand data is other data in the master node except the target data.

In a feasible manner, the data acquiring worker node is configured to send a data update instruction to the master node;
the master node is configured to in response to the data update instruction, send updated data to the data acquiring worker node;
the data acquiring worker node is configured to acquire the updated data from the master node, and store the updated data to the coordination worker node, where the updated data is changed data in the target data.

In a feasible manner, a proxy module of the data acquiring worker node sends the first data acquiring instruction to the master node;
the master node is configured to in response to the first data acquiring instruction, send the target data to the proxy module of the data acquiring worker node;
the proxy module of the data acquiring worker node is configured to receive the target data sent by the master node, and store the target data to the coordination module of the coordination worker node.

In a feasible manner, the proxy module of the data acquiring worker node is configured to:
send the target data to the coordination module, so that the coordination module receives the target data and writes the target data into a storage.

In a feasible manner, each of the at least two worker nodes includes a service module and the proxy module;
before the coordination worker node responding to the second data acquiring instruction sent by the further worker node:
the service module of the further worker node is configured to send the second data acquiring instruction;
the proxy module of the further worker node is configured to intercept the second data acquiring instruction, and send the second data acquiring instruction to the coordination worker node.

In a feasible manner, the coordination worker node further includes the coordination module;
the coordination module is configured to receive the second data acquiring instruction sent by any one of proxy modules, and send the target data to the proxy module;
the proxy module is configured to in a case that the target data is received, send the target data to a corresponding service module.

An embodiment of the present specification provides a data transmission system, including a master node, at least two worker nodes, and a data acquiring worker node and a coordination worker node determined from the at least two worker nodes, where the master node is configured to in response to a first data acquiring instruction sent by the data acquiring worker node, send target data to the data acquiring worker node; the data acquiring worker node is configured to receive the target data sent by the master node, and store the target data to the coordination worker node; the coordination worker node is configured to in response to a second data acquiring instruction sent by a further worker node, send the target data to the further worker node, where the further worker node is a worker node other than the coordination worker node among the at least two worker nodes. By determining a data acquiring worker node in the worker nodes and the data acquiring worker node acquiring the target data from the master node and storing it to the coordination worker node, when acquiring data, not every worker node needs to acquire the data from the master node, so as to reduce communication traffic between the master node and the worker node.

The above is a schematic solution of a data transmission apparatus in the embodiment. It should be noted that the technical solution of the data transmission apparatus and the technical solution of the above data transmission method belong to a same concept. For details that are not described in detail in the technical solution of the data transmission apparatus, please refer to the description of the technical solution of the above data transmission method.

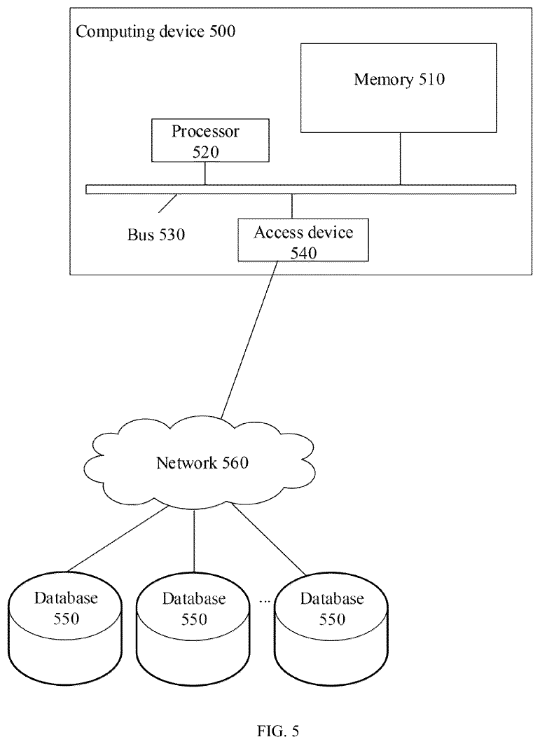

FIG. 5 shows a structural block diagram of a computing device 500 provided according to an embodiment of the present specification. Components of the computing device 500 include, but are not limited to, a memory 510 and a processor 520. The processor 520 is connected to the memory 510 through a bus 530, and a database 550 is used to store data.

The computing device 500 further includes an access device 540 that enables the computing device 500 can perform a communication via one or more networks 560. Examples of these networks include a public switched telephone network (PSTN), a local area network (LAN), a wide area network (WAN), a personal area network (PAN), or a combination of communications networks such as the Internet. The access device 540 may include one or more of any type of network interface (e.g., a network interface card (NIC)), wired or wireless, such as an IEEE802.11 wireless local area network (WLAN) wireless interface, a global interconnection for microwave access (Wi-MAX) interface, an Ethernet interface, a universal serial bus (USB) interface, a cellular network interface, a Bluetooth interface, a near field communication (NFC) interface, etc.

In an embodiment of the present specification, the above components of the computing device 500 and other components not shown in FIG. 5 may also be connected to each other, for example through a bus. It should be understood that the structural block diagram of the computing device shown in FIG. 5 is for illustrative purposes only and does not limit the scope of the present description. Those skilled in the art can add or replace other components as needed.

The computing device 500 may be any type of stationary or mobile computing device, including a mobile computer or mobile computing device (e.g., a tablet computer, a personal digital assistant, a laptop computer, a notebook computer, a netbook, etc.), a mobile telephone (e.g., a smartphone), a wearable computing device (e.g., a smart watch, smart glasses, etc.) or other type of mobile device, or a stationary computing device such as a desktop computer or PC. The computing device 500 may also be a mobile or a stationary server.

The processor 520 is configured to execute the following computer executable instructions, when the computer executable instructions are executed by the processor, the steps of the above data transmission method and the above method for communication between the cloud master node and the edge node are implemented.

The above is a schematic solution of the computing device in the embodiment. It should be noted that the technical solution of the computing device and the technical solution of the above data transmission method belong to a same concept. For details that are not described in detail in the technical solution of the computing device, please refer to the description of technical solutions of the above data transmission method and the above method for communication between the cloud master node and the edge node.

An embodiment of the present specification further provides a computer readable storage medium, having computer executable instructions stored therein, when the computer executable instructions are executed by a processor, the steps of the above data transmission method are implemented.

The above is a schematic solution of the computer readable storage medium in the embodiment. It should be noted that the technical solution of the storage medium and the technical solution of the above data transmission method belong to a same concept. For details that are not described in detail in the technical solution of a storage medium, please refer to the description of technical solutions of the above data transmission method and the above method for communication between the cloud master node and the edge node.

An embodiment of the present specification further provides a computer program, where when the computer program is executed in a computer, the computer is caused to execute the steps of the above data transmission method and the method for communication between the cloud master node and the edge node.

The above is a schematic solution of the computer program in the embodiment. It should be noted that the technical solution of the computer program and the technical solution of the above data transmission method belong to a same concept. For details that are not described in detail in the technical solution of the computer program, please refer to the description of technical solutions of the above data transmission method and the above method for communication between the cloud master node and the edge node.

The specific embodiments of the present specification are described above. Other embodiments are within the scope of the appended claims. In some cases, the actions or steps recited in the claims may be executed in a different order than in the embodiments with still desired results achieved. Additionally, the processes depicted in the figures do not necessarily require the specific order or sequential order shown to achieve desirable results. In certain implementations, multitasking and parallel processing are also possible or may be advantageous.

A computer instruction includes a computer program code, which may be in a form of a source code, an object code, an executable file or some intermediate form. The computer readable medium may include: any entity or apparatus that can carry the computer program code, a recording medium, a U disk, a mobile hard disk, a magnetic disk, an optical disk, a computer memory, a read-only memory (ROM, Read-Only Memory), a random access memory (RAM, Random Access Memory), an electrical carrier signal, a telecommunications signal, and a software distribution medium, etc. It should be noted that addition or deletion may be appropriately made to the content contained in the computer readable medium according to the requirements of legislation within the jurisdiction and patent practice. For example, in some jurisdictions, according to the legislation and the patent practice, the computer readable medium does not include the electrical carrier signal and the telecommunications signal.

It should be noted that for the convenience of description, each of the foregoing method embodiments is expressed as a series of action combinations. However, those skilled in the art should know that the embodiments of the present specification are not limited by the described action order, because in accordance with the embodiments of the present specification, certain steps may be executed in other orders or at the same time. In addition, those skilled in the art should also know that the embodiments described in the specification are preferred embodiments, and the actions and modules involved are not necessarily necessary for the embodiments of the present specification.

In the above embodiments, each embodiment is described with its own emphasis. For parts that are not described in detail in a certain embodiment, please refer to the relevant descriptions of other embodiments.

The preferred embodiments of the present specification disclosed above are only used to help explain the present specification. Optional embodiments are not described in all details, nor are the inventions limited to the specific embodiments described. Obviously, many modifications and changes may be made according to the contents of the embodiments of the present specification. These embodiments selected and described in detail in the present specification are used for better explaining the principles and practical applications of the embodiments in the present specification, so that those skilled in the art can better understand and utilize the present specification. The present specification is limited only by the claims and their full scope and their equivalents.

1. A data transmission method, which is applied to a data transmission system, wherein the data transmission system comprises a master node, at least two worker nodes, and a data acquiring worker node and a coordination worker node determined from the at least two worker nodes, and the method comprises:
in response to a first data acquiring instruction sent by the data acquiring worker node, sending, by the master node, target data to the data acquiring worker node;
receiving, by the data acquiring worker node, the target data sent by the master node, and storing the target data to the coordination worker node; and
in response to a second data acquiring instruction sent by a further worker node, sending, by the coordination worker node, the target data to the further worker node, wherein the further worker node is a worker node other than the coordination worker node among the at least two worker nodes.

2. The method according to claim 1, further comprising:
determining, through an election mechanism, the data acquiring worker node among the at least two worker nodes.

3. The method according to claim 2, wherein the determining, through the election mechanism, the data acquiring worker node among the at least two worker nodes comprises:
sending, by the at least two worker nodes, lock instructions to the coordination worker node; and
receiving, by the coordination worker node, the lock instructions sent by the at least two worker nodes, and in a case that a lock instruction is received, determining the data acquiring worker node according to the lock instructions.

4. The method according to claim 1, further comprising:
acquiring, by a target worker node among the at least two worker nodes, demand data from the coordination worker node, and in a case that the demand data does not exist in the coordination worker node, sending a third data acquiring instruction to the master node;
in response to the third data acquiring instruction, sending, by the master node, the demand data to the target worker node; and
receiving, by the target worker node, the demand data, wherein the demand data is other data in the master node except the target data.

5. The method according to claim 1, further comprising:
sending, by the data acquiring worker node, a data update instruction to the master node;
in response to the data update instruction, sending, by the master node, updated data to the data acquiring worker node; and
acquiring, by the data acquiring worker node, the updated data from the master node, and storing the updated data to the coordination worker node, wherein the updated data is changed data in the target data.

6. The method according to claim 1, wherein each of the at least two worker nodes comprises a service module and a proxy module;
before the coordination worker node responding to the second data acquiring instruction sent by the further worker node, the method further comprises:
sending, by the service module of the further worker node, the second data acquiring instruction to the master node; and
intercepting, by the proxy module of the further worker node, the second data acquiring instruction, and sending the second data acquiring instruction to the coordination worker node.

7. The method according to claim 6, wherein the coordination worker node further comprises [[the]] a coordination module;
receiving, by the coordination module, the second data acquiring instruction sent by the proxy module, and sending the target data to the proxy module; and
in a case that the target data is received, sending, by the proxy module, the target data to the corresponding service module.

8. The method according to claim 7, further comprising:
sending, by the proxy module of the data acquiring worker node, the first data acquiring instruction to the master node;
in response to the first data acquiring instruction, sending, by the master node, the target data to the proxy module of the data acquiring worker node; and
receiving, by the proxy module of the data acquiring worker node, the target data sent by the master node, and storing the target data to the coordination module of the coordination worker node.

9. The method according to claim 8, wherein the storing the target data to the coordination module of the coordination worker node comprises:
sending, by the proxy module of the data acquiring worker node, the target data to the coordination module, so that the coordination module receives the target data and writes the target data into a storage.

10. A method for communication between a cloud master node and an edge node, which is applied to a data transmission system, wherein the data transmission system comprises the cloud master node, at least two edge nodes, and a data acquiring edge node and a coordination edge node determined from the at least two edge nodes, comprising:
in response to a first data acquiring instruction sent by the data acquiring edge node, sending, by the cloud master node, target data to the data acquiring edge node;
receiving, by the data acquiring edge node, the target data sent by the cloud master node, and storing the target data to the coordination edge node; and
in response to a second data acquiring instruction sent by a further edge node, sending, by the coordination edge node, the target data to the further edge node, wherein the further edge node is an edge node other than the coordination edge node among the at least two edge nodes.

11. A data transmission system, comprising a master node, at least two worker nodes, and a data acquiring worker node and a coordination worker node determined from the at least two worker nodes, wherein,
the master node is configured to in response to a first data acquiring instruction sent by the data acquiring worker node, send target data to the data acquiring worker node;
the data acquiring worker node is configured to receive the target data sent by the master node and store the target data to the coordination worker node; and
the coordination worker node is configured to in response to a second data acquiring instruction sent by a further worker node, send the target data to the further worker node, wherein the further worker node is a worker node other than the coordination worker node among the at least two worker nodes.

12. The system according to claim 11, wherein each of the at least two worker nodes comprises a service module and a proxy module;
before the coordination worker node responding to the second data acquiring instruction sent by the further worker node,
the service module of the further worker node is configured to send the second data acquiring instruction to the master node; and
the proxy module of the further worker node is configured to intercept the second data acquiring instruction and send the second data acquiring instruction to the coordination worker node.

13. The system according to claim 12, wherein the coordination worker node further comprises a coordination module;
the coordination module is configured to receive the second data acquiring instruction sent by the proxy module, and send the target data to the proxy module; and
the proxy module is configured to in a case that the target data is received, send the target data to the corresponding service module.

14. A computing device, comprising:
a memory; and
a processor;
the memory is used to store computer executable instructions, the processor is used to execute the computer executable instructions, when the computer executable instructions are executed by the processor, steps of the method according to claim 1 are implemented.

15. The computing device according to claim 14, wherein when the computer executable instructions are executed by the processor, the following steps are implemented:
determining, through an election mechanism, the data acquiring worker node among the at least two worker nodes.

16. The computing device according to claim 15, wherein when the computer executable instructions are executed by the processor, the following steps are implemented:
sending, by the at least two worker nodes, lock instructions to the coordination worker node; and
receiving, by the coordination worker node, the lock instructions sent by the at least two worker nodes, and in a case that a lock instruction is received, determining the data acquiring worker node according to the lock instructions.

17. The computing device according to claim 14, wherein when the computer executable instructions are executed by the processor, the following steps are implemented:
acquiring, by a target worker node among the at least two worker nodes, demand data from the coordination worker node, and in a case that the demand data does not exist in the coordination worker node, sending a third data acquiring instruction to the master node;
in response to the third data acquiring instruction, sending, by the master node, the demand data to the target worker node; and
receiving, by the target worker node, the demand data, wherein the demand data is other data in the master node except the target data.

18. A computing device, comprising:
a memory; and
a processor;
the memory is used to store computer executable instructions, the processor is used to execute the computer executable instructions, when the computer executable instructions are executed by the processor, steps of the method according to claim 10 are implemented.

19. A non-transitory computer readable storage medium, having computer executable instructions stored thereon, wherein the instructions are executed by a processor, steps of the method according to claim 1 are implemented.

20. A non-transitory computer readable storage medium, having computer executable instructions stored thereon, wherein the instructions are executed by a processor, steps of the method according to claim 10 are implemented.
